(19) United States
(12) Patent Application Publication
(10) Pub. No.: US 2007/0040393 A1
(43) Pub. Date: Feb. 22, 2007

(54) Integrated cable seal lock arrangement

(75) Inventors: James M. McLaughlin, Monee, IL (US); Joshua J. Chesser, Downers Grove, IL (US); Andrew C. Crouse, Woodridge, IL (US); Alex V. DeGutis, East Chicago, IN (US); Peter J. Gubricky, Oswego, IL (US); Charles L. Horne, Chicago, IL (US); David A. Oestermeyer, Downers Grove, IL (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(73) Assignee: Salco Products, Inc., Lemont, IL (US)

(21) Appl. No.: 11/511,037

(22) Filed: Aug. 28, 2006

Related U.S. Application Data
(63) Continuation-in-part of application No. 10/735,215, filed on Dec. 11, 2003, now Pat. No. 7,097,217.

(51) Int. Cl. E05B 39/02

(52) U.S. Cl. 292/284

(57) ABSTRACT

The present disclosure is directed to cable seal locks with a body assembly integrated with structures defining storage or transportation chambers or compartments or the closure member components therefor. A cable seal lock body assembly is integrated with a component defining a receptacle or a separate mounting housing. The housing, in one form includes a slot to receive a mounting strap. In other forms, the housing includes a mounting base and a separate top portion that receives the lock body assembly. The top portion and base are assembled after attachment of the base to a component of a storage compartment or closure member. The lock body housing prevents removal of the top portion from the base and the base from the component.

### RELATED APPLICATIONS

This application is a continuation-in-part application of U.S. application Ser. No. 10/735,215 filed Dec. 11, 2003.

### BACKGROUND OF INVENTION

This invention relates to cable seal locks. More particularly, it relates to cable seal locks having a body assembly suitable for reuse.

Bulk, and other storage and transportation compartments frequently require security mechanisms to preserve the integrity of the contents of the compartments. Often it is desirable to be aware of instances of unauthorized opening of, or entry into, such compartments through the covered access opening associated with the compartment into such compartments. This is particularly true in those situations where theft or contamination of the contents of the compartments is otherwise difficult to ascertain. Such situations exist, for example, where the contents of the compartment is in bulk or infrequently inventoried, or where even small amounts of certain contaminants are unacceptable. Comprehensive testing for contaminants is usually impractical or prohibitively expensive.

Certain security devices, such as the ordinary padlock, usually do not provide an indicia of tampering. A successful thief or saboteur that defeats such a device can easily reaffix it or install a similar or duplicate device if the original was destroyed without leaving behind any indication of access.

Cable seal locks are security devices that can provide the sort of indication of unauthorized access that is often desirable. Cable seal locks are single use mechanisms. Each lock includes a body assembly and a cable. Often, one end of the cable is attached to the body assembly. Examples of such locks are found in U.S. Pat. Nos. 5,222,776; 5,353,003; and 5,582,447.

Typically, the body assembly includes a housing defining one or more passages and a retention mechanism. The free end of the cable is inserted into a passage of the lock body assembly. The retention mechanism allows entry of the cable into the body housing in one direction but does not allow removal of the cable in the other direction without extreme force. In the case where one end of the cable is attached to the body housing of the lock body assembly, inserting the free end of the cable into the mechanism through the passage results in a loop of cable, which can be passed through a hasp or similar device near the access closure of the compartment to be secured, such that to gain access to the compartment through the access closure, the loop of the cable must be cut.

Another form of cable lock involves a cable that is not attached to the body but that includes an abutment or head opposite the free end that prevents the cable from passing through the passage in the lock body. In this situation the cable acts as a latch pin or deadbolt that can be threaded through the hasp or similar device on the closure and through lock body passage to engage the retention mechanism. The cable of this type of cable seal lock also must be destroyed by cutting the cable between the abutment and the body housing for access to the compartment.

The lock body or the abutment of the cable of a cable seal lock can be labeled, painted or serially numbered for additional security.

When creating a seal with the cable seal lock, the cable is advantageously passed through the lock body passage so that a maximum amount of cable is passed through the passage and therefore, once the cable is cut to remove the seal from the protected closure a minimum amount of cable remains attached to the lock body. This prevents the seal from being remade with the same cable, which would defeat the purpose of the cable seal lock, and also ensures a tight closure involving minimal slack of the cable and therefore minimal freedom of movement of the components of the closure mechanism. Because the seal cannot be remade with the same cable, broken cable or missing or mis-numbered security devices provide evidence of opening of the closure and possible entry into the compartment.

In all security applications involving cable seal locks, the cable must be cut to allow for entry, authorized or otherwise. Once cut, the cable seal lock, still attached to one end of the cable and the other severed end of cable, which now can be removed from the lock, are discarded. Thus, while security protocols involving cable seal locks advantageously provide indicia of possible unauthorized access or entry into storage or transportation compartments, they disadvantageously involve significant cost owing to the disposable nature of the cable seal lock security devices.

In some storage or transportation situations, the disadvantage of a security protocol involving cable seal locks is heightened because a large number of cable seal locks must be used routinely. Railroad hopper cars, for example, sometimes each involve eight or ten hatch covers that must be sealed after the car's compartments are filled. In the usual case, these seals must be removed each time the compartment is filled or emptied. Typically a train has many cars of the same type and therefore the number of cable seal locks required for every train is substantial. Because cable seal locks are not designed for re-use, each cycle of filling, delivering, emptying and refilling a car consumes a large number of locks. In other situations as well, a large number of cable seal locks must be routinely purchased to provide adequate security for storage or transportation compartments.

### SUMMARY OF THE INVENTION

The present invention is directed to a security protocol involving cable seal locks that avoids the expense of providing a new a lock body assembly after each instance of access to a storage or transportation compartment or other vessel with a covered access opening. More specifically, the present invention is directed to a security protocol and security systems involving a cable seal lock created with a cable lock body assembly that is reusable. In a preferred form, the body assembly is incorporated into a receptacle formed by the structure of a storage or transportation compartment or the closure member for such compartment. In another form, a separate mounting housing is provided that defines the receptacle for the lock body housing. The defining feature of a cable seal lock arrangement according to the present invention is that the cable seal lock body assembly is arranged for subsequent reuse with a new cable.

The invention has many applications. Storage sheds, lockers, equipment compartments, vessels and other containers or secure space defining structures with a door or cover that provides interior access are examples. One such application, involving railroad car security, is described in detail below. The embodiments of the present invention described below, and the particular application to which they are directed, are illustrative only and not limiting. A detailed description of these embodiments directed to particular applications is illustrative of the inventive concept applicable to a wide range of storage or transportation compartments and associated closure members.

### BRIEF DESCRIPTION OF THE DRAWINGS

FIGS. 1A and 1B are partial sectional views of cable lock mechanisms known in the art.

FIG. 2 is a side view, illustrating a known latch mechanism for the railroad hopper car hatch cover.

FIG. 3 is a perspective view of a portion of the apparatus of FIG. 2.

FIG. 4A is a perspective view of a catch adaptor for the mechanism depicted in FIG. 2 configured in accordance with the present invention.

FIG. 4B shows a cable seal lock body assembly integrated with the catch adaptor of FIG. 4A.

FIG. 5 shows the railroad hopper car hatch cover locking clasp mechanism of FIG. 2 with the cable seal lock installed.

FIG. 6A is a fragmentary cross-sectional view of a receptacle with a cable lock body assembly installed.

FIG. 6B shows a cable lock body assembly in the receptacle and a cable inserted into a cable lock body assembly and a snap ring retainer.

FIG. 6C shows the snap ring used with the receptacle depicted in FIGS. 6A and 6B.

FIG. 7A shows cable seal lock body housing configured for use with a complementary receptacle or mounting housing.

FIG. 7B shows a receptacle or mounting housing to receive the lock body housing of FIG. 6A.

FIG. 8 is a perspective view of a cable lock body assembly and mounting housing arranged in accordance with one aspect of the present invention.

FIG. 9A is a perspective view of a cable seal lock body assembly and mounting housing arranged in accordance with another aspect of the present invention.

FIG. 9B is a perspective view of a modified form of the mounting housing of FIG. 9A.

FIG. 9C is a plan view, partially in section, showing the apparatus of FIG. 9A attached to a structure to be secured.

FIG. 10A is a perspective view illustrative of an embodiment of a mounting housing of the present invention.

FIG. 10B shows an exploded view of the apparatus of FIG. 10A.

FIG. 10C is a perspective view of components of the mounting housing shown in FIG. 10A repositioned 180° relative to FIGS. 10A and 10C to illustrate specific features.

FIG. 10D is a side view, in section, of the mounting housing of FIGS. 10A through 10C.

FIG. 10E shows a side plan view, in section, of the components of FIG. 10B on top of a storage or transportation structure showing an assembly sequence.

FIG. 10F shows an end view of the mounting housing of FIGS. 10A through 10D.

FIG. 10G shows another arrangement of the mounting housing of FIGS. 10A-10D.

FIG. 11A shows an exploded view of another embodiment of a mounting housing illustrative of the principles of the present invention.

FIG. 11B shows a side view, partially in section, of the components of the embodiment depicted in FIG. 11A assembled to a storage or transportation structure.

FIG. 11C is a sectional front view of a mounting housing and component to be secured, illustrative of the principles of the present invention.

FIG. 11D is a perspective view of a mounting housing and component to be secured illustrative of the principles of the present invention.

### DETAILED DESCRIPTION OF THE ILLUSTRATED EMBODIMENTS

Railroad cars, such as hopper cars carrying bulk particulate material, often involve covered hatches or openings on the top of the car that are opened for filling the car with payload, and venting the car during removal of the payload. Such cars can carry, for example, plastic pellets to be used in injection molding for food containers or packaging. The hatches of these cars are equipped with covers secured with security mechanisms to discourage occurrences of contamination or theft, or at least to provide indicia of theft or contamination of the payload through the hatches. The security mechanism used on the hatches of railroad cars is typically a cable seal lock of the various types discussed.

Cable seal locks work in this situation by providing a cable that prevents the opening of the hatch's cover by looping around, or passing through, a part of the hatch cover latch mechanism that must be operated to allow the hatch cover itself to be opened.

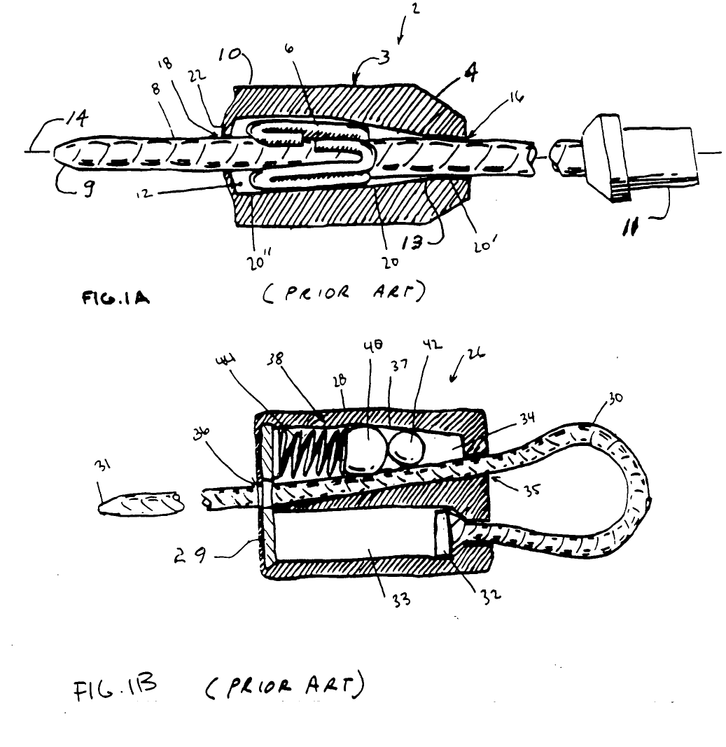

FIGS. 1A and 1B show types of cable lock mechanisms known in the art of cable seal locks that are often useful in this application. Both of the locks depicted, and most cable seal locks generally, involve applying orthogonal pressure on the cable when the cable is passed in one direction through a passage in the lock body assembly and involve relatively little orthogonal pressure applied to the cable when the cable is passed through the passage in the lock body assemblies in the opposite direction. Cable seal apparatus such as illustrated in FIGS. 1A and 1B are well known and are further illustrated and disclosed in U.S. Pat. Nos. 5,222,776; 5,352,003; and 5,582,447, the disclosures of which are hereby incorporated by reference.

FIG. 1A depicts a cable seal lock assembly described in more detail in U.S. Pat. No. 5,582,447.

In FIG. 1A, cable seal lock 2 comprises a lock body assembly 3, including a lock body housing 10, and a retention mechanism that includes serpentine shaped spring clip 6. The lock 2 further includes a stranded metal cable 8 with a swaged end or abutment 11 which cooperates with the lock body assembly 3. The cable seal lock 2 can be used to secure a container lid or door.

The lock body housing 10 in FIG. 1A is preferably made of hardened metal, but could be molded thermoplastic or other metals in the alternative according to a given implementation. The body housing 10 sometimes referred to as a casing, defines passage 12 concentric with longitudinal axis 14. The body housing 10 defines cable openings 16 and 18 at opposite ends. Between the opening is tapered housing bore 20 which coacts with clip 6 as a element of the retention mechanism.

The tapered bore 20 preferably comprises two sections, a tapered portion 20′ starting at narrow end 13 and a second enlarged tapered portion 20″. The portion 20′ merges tangentially with portion 20 to form a smooth continuous annular bore surface in the body housing 10. The housing 10 includes an annular wall flange 22 which retains serpentine spring or clip 6.

The spring 6 is disposed in the passage 12 at the larger bore diameter portion 20″ of the body housing 10. The cylindrical bore portion 20″ has an axial extent larger than the length of clip 6 so the clip 6 can longitudinally displace therein. The body 10 at opening 16 defines an axial extent of bore 20″ to serve as a guide of the face end 9 of cable 8 into the passage 12.

The free end 9 of cable 8 is sized to pass through a hasp or other device to be secured. It is also sized to pass through passage 12. As the cable 8 is moved farther into the lock body passage 12, the clip 6 is allowed to move into the wider portion of tapered bore portion 20″ of the lock body passage 12. There, the serpentine spring 6 relaxes and expands away from the cable, releasing the cable 8 and allowing to move freely through the lock body passage 12 in one direction. Flange 22 prevents clip 6 from leaving passage 12 completely.

Abutment 11, attached to cable 8, is sized to prevent cable 8 from passing entirely through the hasp or other secured device or through passage 12 of cable seal lock body assembly 3. Orthogonal pressure applied to the cable 8 is created by the serpentine spring or cable 6 which is, in essence, a cylindrical cuff that compresses onto the cable 8 as it is encouraged by friction from the surface of the cable 8 into the tapered portion 20″ of the lock body passage 12.

Once the cable 8 is inserted in the cable lock housing assembly 10, it must be cut between the housing 10 and abutment 11 to be removed.

FIG. 1B depicts a cable seal lock described in more detail in U.S. Pat. No. 5,222,776.

The cable seal lock 26 includes a body assembly 23 and a cable 30. Cable 30 is a stranded steel cable having a free end 31 and includes a swaged or similarly formed head or abutment 32 at its other end.

Cable seal lock body housing 28 is closed at one end by cap 29. It defines two passages 33 and 34. Passage 33 is closed at one end by cap 29 and has an opening at the other through which the cable 30 passes. The head or abutment 32 is permanently received within passage 33.

Passage 34 extends through housing body 28 which defines opening 35. Cap 29 includes openings 36. Both are sized to pass the cable 30. The opening 35 is at the same end of housing 28 as the opening through which the cable extends from passage 33. The cable is of a length to be looped around and the free end passed into passage 34 through opening 35 and out of passage 34 through opening 36.

The inner wall defining through passage 34 is tapered toward opening 35. The passage 34 is defined by a conical locking surface 37 that diverges toward opening 36.

Passage 34 is substantially larger adjacent opening 36 and contains one way locking or retention mechanism 38. Locking mechanism 38 includes a pair of locking balls 40 and 42 that contact the cable 30. Spring 44 urges the balls toward the small end passage 34 defined by conical wall 37 adjacent opening 35.

In use, the free end 31 of cable 30 that extends from passage 33 is passed through a member to be locked against entry and then inserted into opening 35. As it is passed into through passage 34 the free end 31 displaces the balls 40 and 42 of one-way lock mechanism 38 along tapered wall 37 in passage 34 away from the small end of conical wall portion 37.

The orthogonal pressure applied to the cable 30 is created by balls 40 and 42 acting along the conical, tapered surface 37 of the lock body passage 34 in body 28. Balls 40 and 42 are urged toward the narrow end of the through passage 34 by spring 44. Cable end 31 entering passage 34 through opening 35 applies a force to balls 40 and 42 and moves them toward the opening 36 of the passage 34 so as to compress spring 44. With balls 44 at the wider end of the passage 34, little or no orthogonal pressure is applied against the cable 30, which is therefore able to pass through freely. When it is attempted to pull the cable 30 from the opening 36 of the passage 34, balls 40 and 42 move in the direction of the cable 30 and into the small end of tapered lock surface 37 of passage 34. The balls 40 and 42 apply orthogonal pressure on the cable 30 to prevent its movement in that direction. The spring 44 as well as friction of the cable 30 on balls 40 and 42 encourages the movement of balls towards the lock surface 37. As in the cable lock of FIG. 1A, the cable must be cut between head 32 and opening 35 of through passage 34 to remove the lock.

Other types of cable seal locks, not depicted in the drawings, but compatible with the present invention, also typically involve orthogonal pressure applied to a cable when effort is applied to remove it from the lock body in a direction of opposite the direction of insertion. U.S. Pat. Nos. 4,681,355; 4,747,631; 5,352,003; and 5,611,583, are directed to such other cable seal locks. Each of these locks have in common that a cable is allowed to move through the lock body passage in only one direction with movement in the other direction resisted by the retention mechanism in the lock body housing. Bi-directional cable seal locks (which permit entry of a cable into their passage from either end but prevent retrogression of the cable in the direction opposite the direction of entry) also can be used with any embodiment of the present invention. Removal of the cable requires that it be cut between the head or abutment end and the entry into the lock body housing assembly.

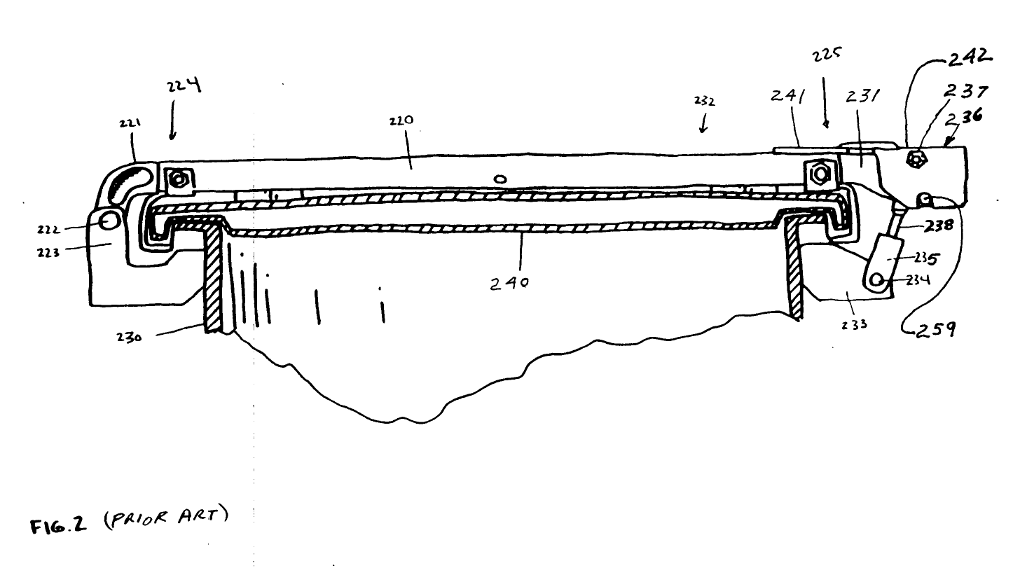

FIGS. 2 through 5 illustrate application of the principles of the present invention with a railroad hopper car hatch cover latch mechanism. In this embodiment, a cable seal lock body assembly 203 such as described above in connection with FIG. 1A, is integrated with certain structures that provide covered access and which are to be secured. The inventive approach permits reuse of the cable seal lock body assembly with a new cable each time the structure is secured.

FIG. 2, illustrates a railroad hopper car hatch cover and latch mechanism assembly described in more detail in U.S. Pat. No. 5,738,396, the disclosure of which is incorporated by reference.

There is illustrated a latch cover 240 closing the loading nozzle 230 of a railroad hopper car. A manually operable latch mechanism generally designated 232 releasably secures the cover 240 on nozzle 230.

As illustrated in FIG. 2, the latch mechanism includes elongated arm 220 is connected to hinge adaptor 221 at one end 224 and catch adaptor 231 at the other end 225. Together these components form a cover latching bar. Hinge adaptor 221 is connected by hinge pin 222 to hinge bracket 223, on nozzle 230. Catch bracket 233 is secured to nozzle 230 across from hinge bracket 223, and is connected by catch bolt 234 to clevis 235. Locking clasp 236 includes a handle portion 241. Clasp 236 is connected by pin 237 to shank 238 and clevis 235. When handle portion 241 is lifted, locking clasp 236 pivots on small pegs 239 of catch adaptor 231, until the pins disengage from the clasp 236. The downward closing force applied to loading nozzle 230 and hatch cover 240 is released, allowing elongated arm 220 to pivot about hinge pin 222, thereby allowing hatch cover 240 to be removed from opening defined by loading nozzle 230.

FIG. 3, illustrates the locking clasp 236 of FIG. 2. Side plates 252 of locking clasp 236 define side plate security holes 251. Top plate 242 of handle portion 241 of locking clasp 236 defines handle security hole 253.

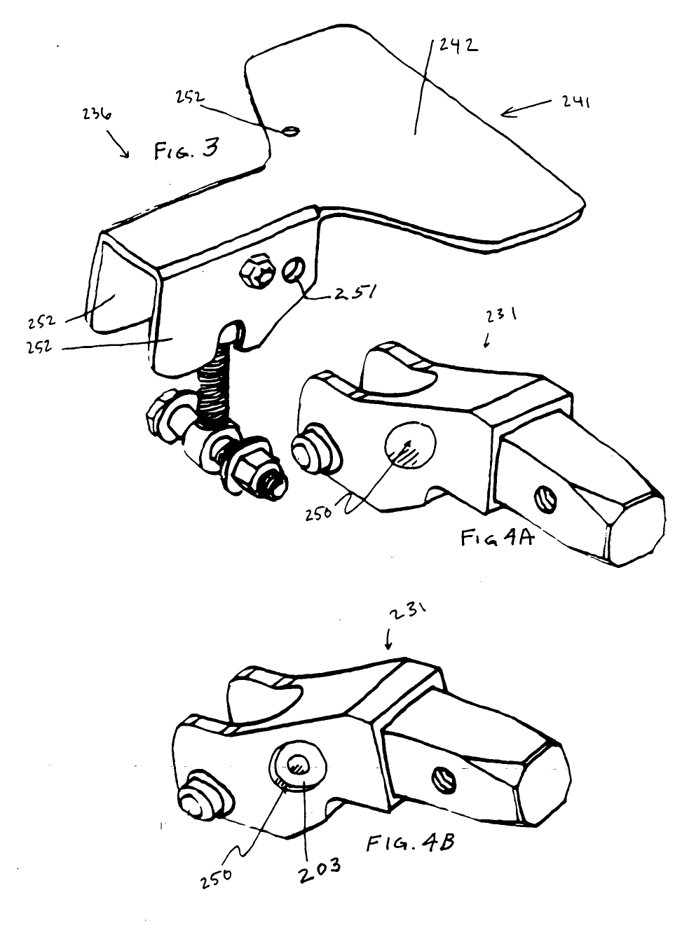

FIG. 4A illustrates the catch adaptor 231 of FIG. 2 modified to incorporate the present invention. It defines receptacle for a cable lock body assembly 203 in the form of bore cavity 250. FIG. 4B shows catch adaptor 231 with integrated cable seal lock body assembly 203 positioned within receptacle 250.

The arrangement includes a cable lock body assembly 203 such as the body assembly 3 of FIG. 1A. It includes lock body housing 210, a serpentine clip or spring such as the spring clip 6. It operates in the same manner as the cable seal lock of FIG. 1A.

This arrangement is illustrative of the principle of incorporating the lock body into a portion of an apparatus to be secured. The selection of the lock mechanism is limited only by dimensions of the parts of the access closure configuration into which the cable seal lock body assembly is to be integrated according to the present invention.

In this embodiment, the cable seal lock body housing 210 is relatively slender and can easily be placed within cavity 250 of catch adapter 231, as shown in FIGS. 4A-4B.

Cable seal lock 202 is similar to cable seal lock 2 of FIG. 1A. It includes a cable 208 with an abutment 211 at one end. Lock body housing 210 is sized to allow locking clasp 236 to pivot on small pegs 239 of catch adaptor 231 when cable is not in cable seal lock 202. Cable seal lock body housing 210 is shown in FIG. 4B as slightly recessed within the sides of catch adaptor 231, but could be configured otherwise and still allow locking clasp 236 to pivot when cable 208 is not in cable seal lock body assembly 203, as, for instance, where sides 252 of locking clasp 236 are relatively farther apart than the width of catch adaptor 231.

FIG. 4B thus depicts cable seal lock body assembly 203 integrated with catch adaptor 231. When a seal is made and cable 208 is in place, cable seal lock 202 is neither loose nor spatially separate from catch adaptor 231, but is integrated with it. When the cable 208 is cut, cable seal lock body assembly 203 remains in its place in catch adaptor 231 which accommodates it in cavity 250.

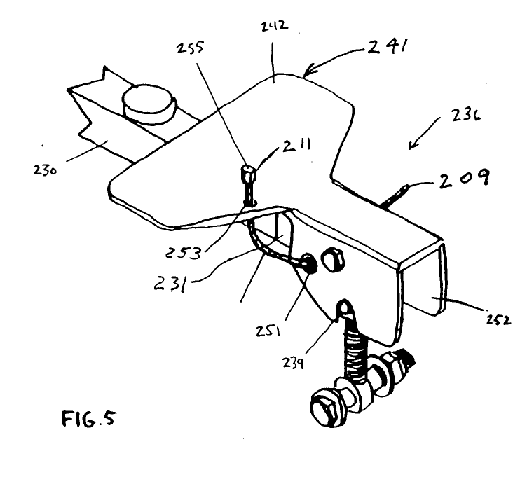

FIG. 5, depicting a sealed railroad hatch cover latch mechanism according to one embodiment of the present invention, shows how free end 209 of cable 208 is attached to the locking clasp mechanism through hole 251 in handle portion 241 of locking clasp 236, then through cable seal lock body assembly 210 of catch adaptor 231. The abutment 211 is closely spaced to the top surface of top plate 242 of handle portion 241. The size of the abutment 211 at the end of cable 211, relative to hole 251 in handle portion 241 of locking clasp 236 prevents cable abutment 211 from advancing through the handle passage such that abutment 211 of cable 208 abuts the handle preventing cable 208 from being easily cut when removal of cable seal is required. Because cable 208 is disposed in holes 251 and also restrained by cable seal lock body assembly 210, it prevents locking clasp 236 from being pivoted upward about small pegs 239 of catch adaptor 231. Once the cable is cut the free end of the cable is separated from the portion with the abutment. Both cable sections can be removed to open the cover.

FIGS. 4B and 5 show a cable seal lock body assembly 203 integrated with a component of the closure member of a railroad hopper car compartment, namely, the catch adaptor 231. Cable seal lock body assembly 203 in FIGS. 4B and 5 is disposed within cavity 250. Side plates 252 of handle 241 cover the receptacle 250. It is therefore not necessary to tightly mount lock body assembly 203 in receptacle 250 except to prevent its loss. The body 210 and cavity 250 of FIGS. 4 and 5 may be configured however so that cable seal lock body housing 210 will fit into cavity 250 only with an interference fit. This configuration has the advantage that cable seal lock body housing assembly 203 can not be readily removed from cavity 250. Requiring force to remove the integrated cable seal lock body assembly 210 can prevent the unintended loss of the reusable cable lock body assembly when a seal is not in place.

The precision of the fit required between cable seal lock body housing 210 and cavity 250 also could be reduced by using an adhesive (not shown) on the surfaces of cable seal lock body housing 210 and cavity 250, which configuration could similarly require a significant amount of force applied to cable seal lock body assembly 203 to remove it.

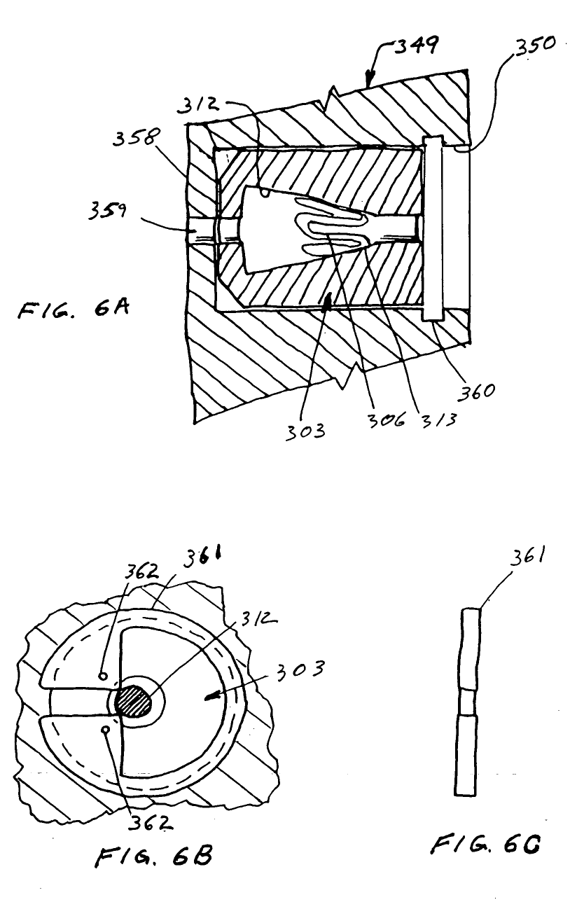

In FIG. 6A, another arrangement is shown. A receptacle 349 is defined by a component such as the catch adapter 231 of FIG. 2, or another suitable component of a cover or closure arrangement. A cavity or bore 350 is provided and is partially defined by annular shoulder or wall 358, with through hole 359. Cavity 358 receives and retains lock body assembly 303 which houses retention mechanism 306. The cable seal lock of this embodiment is similar to that of FIG. 1A. It includes a lock body assembly 303 with retention mechanism 313. A cable 312 such as cable 8 with abutment 11 cooperates with lock body assembly 303.

Shoulder or wall 358 of the receptacle defining component prevents removal of cable seal lock body assembly 303 from one end of cavity 350, but allows a cable 308 to pass through hole 359. This configuration can be advantageous in that wall 358 restrains cable seal lock body assembly 303 from being pushed out of cavity 350 one direction. It is then only necessary to restrain it in the other direction. In this arrangement, force applied to cable seal lock body assembly 303 when cable is inserted is resisted by shoulder 358. The cable seal lock body assembly 303 thus can be placed into cavity 350 with the cable receiving end (which corresponds to narrow end 313 of lock body passage 312) facing outward of cavity 350, away from shoulder 358.

Receptacle 349 further defines groove 360 near the open end of cavity 350, opposite to the end defined by shoulder or wall 358, as shown in FIG. 6A. Groove 360 is within cavity 350 such that when cable seal lock body assembly 303 rests within cavity 350, groove 360 is exposed. Groove 360 accepts snap ring 361, illustrated in FIG. 6C. As shown in FIG. 6B, snap ring 361 is configured such that when compressing pressure is applied to snap ring 361 at eyes 362 to bring eyes 362 together, snap ring 361 is allowed to be inserted into cavity 350, and when pressure is released, snap ring 361 expands to fit into groove 360 of cavity 350. In this way, snap ring 361 prevents the removal of cable seal lock body assembly 303, which fits snugly into cavity 350 when snap ring 361 is in place in groove 360.

Snap ring 361 is configured such that, when a cable 308 is in place, the cable prevents snap ring 361 from being compressed sufficiently to allow for its removal. This protects against the removal of cable seal lock body assembly 303 from cavity 350.

Another possible configuration, not shown, is to reverse the position of the lock body assembly 303 within bore 350. That is, lock body assembly 303 is inserted into cavity 350 with narrow end 313 of lock body housing bore passage 312 proximate wall 358, and with snap ring 361 in groove 360. This way, force applied to pull the cable 308 out of the retention mechanism is resisted by the wall 358.

Although the above-described embodiment of FIGS. 6A-6B depict a cable seal lock integrated with a component of the closure member of a storage and transportation compartment, the features of the present invention described in relation to FIGS. 3-6C could also advantageously be applied such that the cable seal lock is integrated with a separate mounting housing for attachment to the structure defining the chamber of the storage and transportation compartment.

Although existing storage and transportation compartments and their closure members can often be easily retrofitted to exhibit features of the present invention, it is often impractical for various reasons to do so. In such cases, the various embodiments of the present invention described below can prove advantageous.

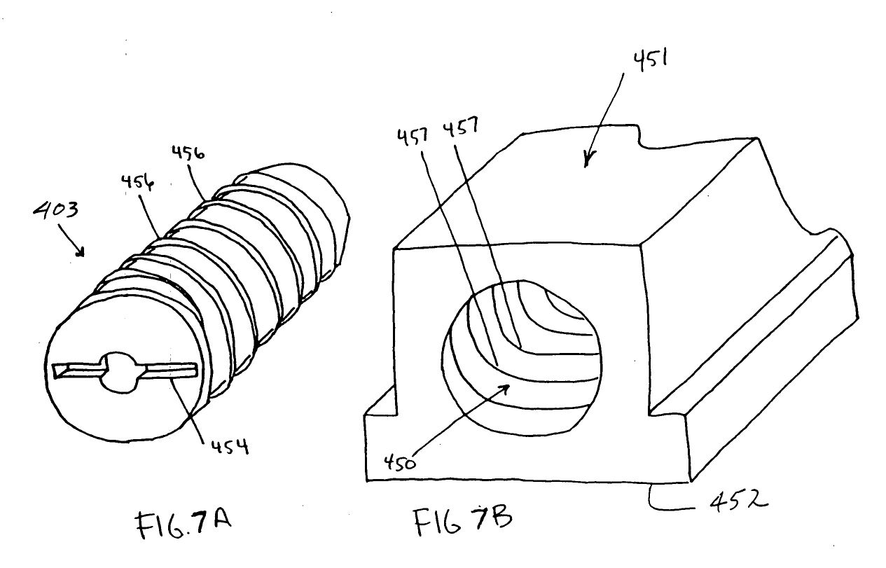

FIGS. 7A-7B depict another integrated cable seal lock embodiment. Here the cable lock body assembly 403 is supported in a mounting housing 451. The housing 451 is provided with an integral base 452 to mount onto an opening defining component or closure member or its latch mechanism. It includes a reception bore 450 to receive and secure the cable lock body assembly 403. The mounting housing base 452 is adapted to be mounted on a surface of a closure or associated frame adjacent a hasp or similar arrangement. The cable of the cable lock is passed through the components of the hasp and the cable lock body assembly supported by the mounting housing. In this embodiment, the outer surface of cable seal lock body housing 403 in FIG. 7A includes threads 456, which correspond to threads 457 formed in bore 450 of a mounting housing 451 shown in FIG. 7B.

The bore 450 for the cable lock body assembly 403 can be of any configuration that accommodates the outer shape and dimensions of cable lock body housing 410, but it preferably complements the exterior surface of the cable lock body housing 410. For instance, as shown in FIG. 7A, both cable seal lock body housing 410 and cavity 450 are cylindrical and threaded with engaging threads.

Slot 454 is provided in lock body housing 410, which matches the head of an instrument such as a screw driver (not shown) capable of delivering torque to cable seal lock back housing 410. Slot 454 can be of any shape to match a flat-head or Phillips head screwdriver, allen wrench, or other instrument capable of delivering torque to cable seal lock body housing 410. Cable seal lock body assembly 403 can thus be rotated into place in cavity 450 in mounting housing 451.

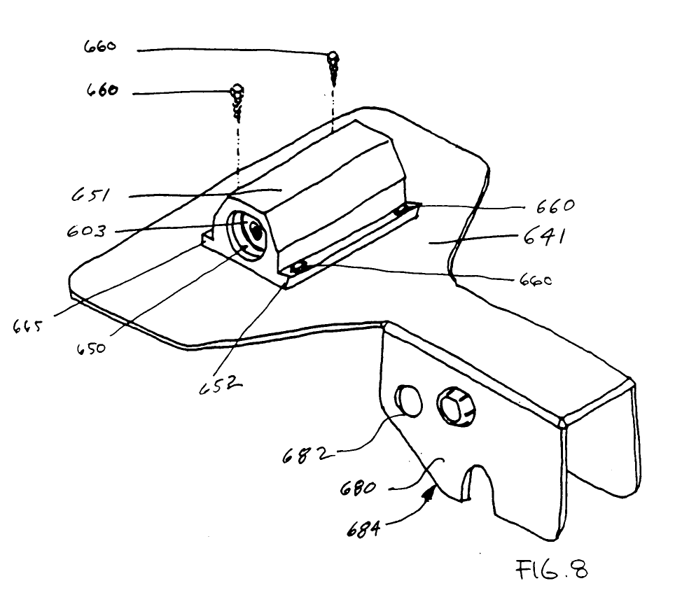

FIG. 8 shows a cable seal lock body assembly 603 integrated with handle portion 641 for a cover similar to handle portion 241 of locking clasp 236 for hatch cover 240 of FIG. 2. The components of the cover and latch mechanism are as previously described except as differentiated below.

The arrangement of FIG. 8 includes separate mounting housing 651. Housing 651 can accommodate cable seal lock body assembly 603 in cavity 650 according to the features of the present invention described above with respect to FIGS. 4A-4B and 6A-7B.

Various ways of integrating mounting housing 651 with handle portion 641 can be used. Housing 651 can be magnetized and therefore capable of attaching to any closure member component that is magnetic. A magnetized housing 651 can be further advantageous in that a magnetic field can be induced in cable seal lock body housing within cavity 650 of mounting housing 651 such that the components of cable seal lock body assembly 603 also become magnetized. This can enhance the functionality of certain cable seal locks, such as the cable seal lock of FIG. 1A, in that, for instance, spring 6 could cling to cable 8, augmenting the frictional force that serves to push spring 6 into tapered bore 20″ of passage 12, thereby releasing the orthogonal pressure on cable 11 that serves to prevent its movement, when cable 8 advances through passage 12. The cable seal lock body could, itself, also be magnetized directly such that it clings directly to the chamber-defining structure or closure member component with which it is to be integrated.

As shown in FIG. 8, mounting housing 651 includes base 652 that accommodates screws or bolts 660 that can secure housing 651 directly to handle portion 641. Of course, it is contemplated that handle portion 641 could also be any chamber-defining structure or closure member component. Also, base 652 defines a flat bottom surface area upon which an adhesive could be used secure mounting housing 651 to handle portion 641. Housing 651 can be of any shape and can preferably be shaped to be compatible with the area of component where it is to be attached. For instance, where housing 651 is to be attached to a cylindrical or curved component, the bottom of housing base 652 can be curved in a complementary fashion.

In the embodiment illustrated in FIG. 8 the cable lock body assembly 603 is oriented in cavity 650 of housing 651 such that the free end of the cable of the cable lock is first passed through the holes 682 in side plates 680 of locking clasp 684, and then inserted into the passage of the cable lock body assembly 603. The abutment of the cable is positioned adjacent the hole 682 in side plate opposite the one shown in FIG. 8. The catch adapter associated with the locking clasp 684 has a through hole that is aligned with the holes 682 in side plates 680 when the latch mechanism is in the latched position. This alignment permits the cable free end to pass through both holes 682 and the hole in the catch adapter. The abutment of the cable is sized such that it will not pass through the holes. The cable secures the locking clasp in the latched position. To open the cover, it is necessary to cut the cable between hole 682 seen in FIG. 8 and the cable lock body assembly 603.

For some applications, direct attachment of a housing to an existing component, such as with bolts, is infeasible. This is the case, for instance, where it is desirable to integrate a cable seal lock body assembly with a component that represents a non-penetrable surface, such as a fluid carrying tube.

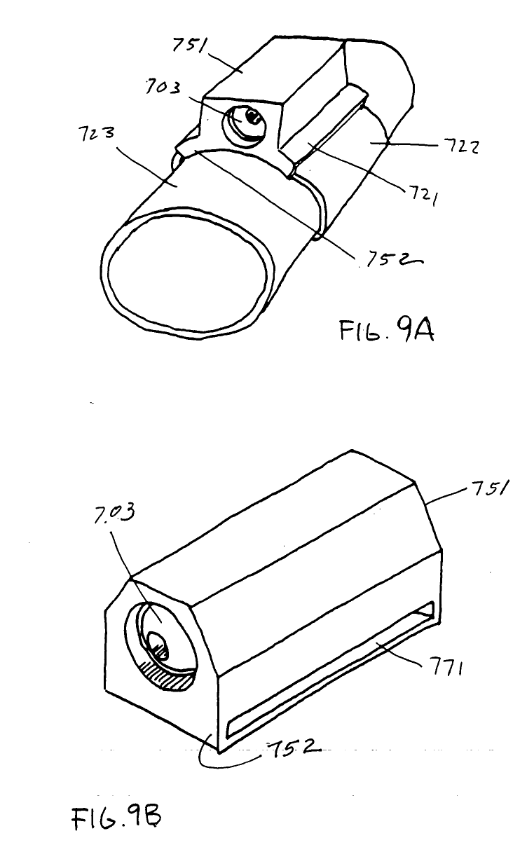

FIGS. 9A-9C show embodiments of the present invention wherein a cable seal lock is contained in a housing that is integrated with a storage or transportation compartment component such as a pipe. In FIG. 9A, housing 751 houses cable seal lock body assembly 703. This connection may be achieved in any of the ways described herein. Housing 751 includes base 752 connected to a strap 722 which wraps around pipe 723 to secure housing 751 to pipe 723.

FIG. 9B shows a modification of the housing shown in FIG. 9A. Housing 780, which houses cable lock body 703, includes base portion 752, which includes slot 771, through which a strap may be laced to secure housing 780 to a pipe or other structure.

In FIG. 9C, pipe 764, which partially defines a chamber or port 767 is in communication with a compartment, the rest of which is not shown. The pipe end defines an access opening 768. Closure member 769 is a cap to secure the opening defined by the pipe end.

Pipe 764 cannot be penetrated to obviate the occurrence of leakage or impairment of its function and since the components of the closure member 769 may not be well adapted to modification according to the features of the present invention described above, pipe 764 is outfitted with strap 766 that attaches mounting housing 751. Housing 751 includes integrated cable seal lock body assembly 703 secured in the housing 751 as previously described with any of the other embodiments. Strap 766 can be of any size or configuration and can be affixed to housing 751 in any number of ways, including rivets, clips, sleeves and the like. Also, as shown in FIGS. 9A and 9C, base 752 of housing 751 may define slot 771, through which strap 766 can be passed and secured to pipe 764. Strap 766 can be made of stainless steel or any other suitable material. The strap ends are secured together at connectors 772.

Also, the mounting housing 780 can be secured to the chamber-defining structure or closure member with a clip or ring in a manner topologically similar to the configuration shown in FIG. 9B, or wherein a clip or ring is looped through a tab or the like in either or both of lock body assembly and the structure or closure member. The cable lock operates as previously described. A cable 708 with abutment 711 is passed through hasp defining protrusions 780, 782 and then through lock body housing assembly 703. Once cut, the cable segments can be removed and cable segments can be removed and cable lock body assembly 203 reused.

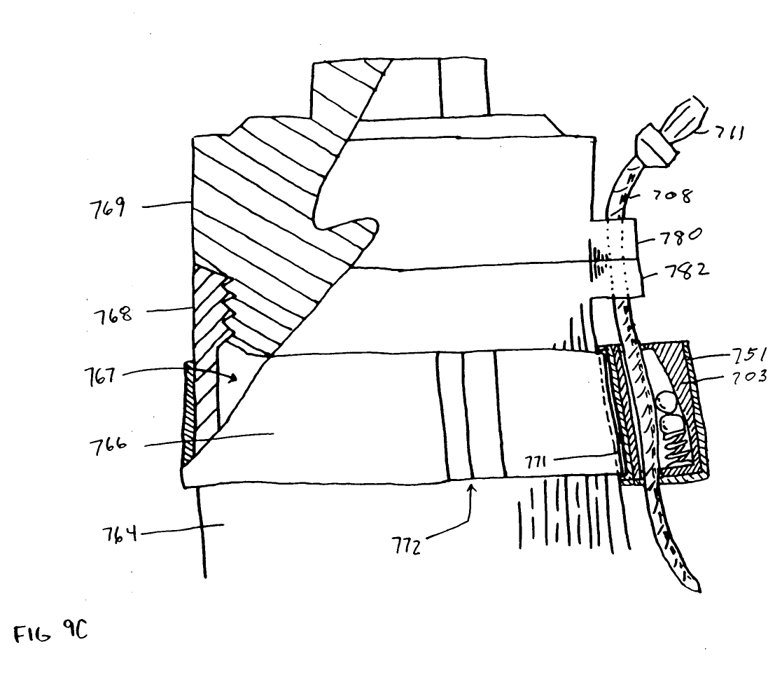

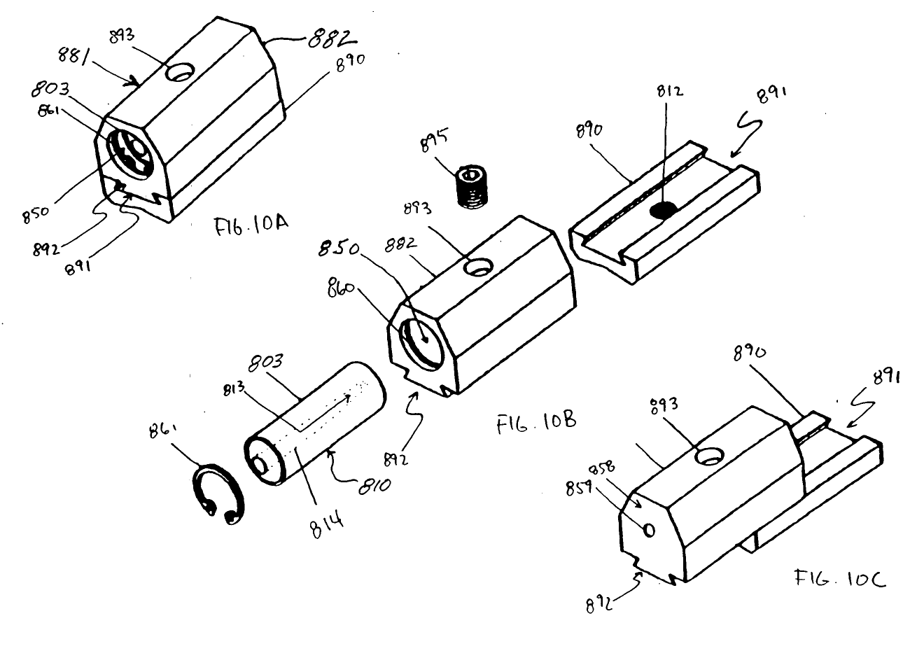

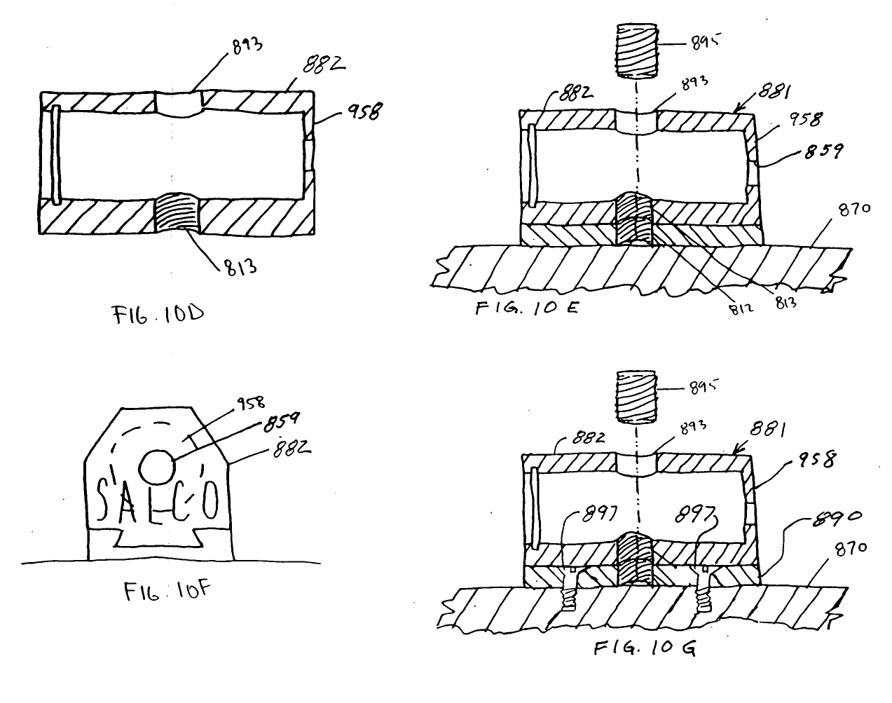

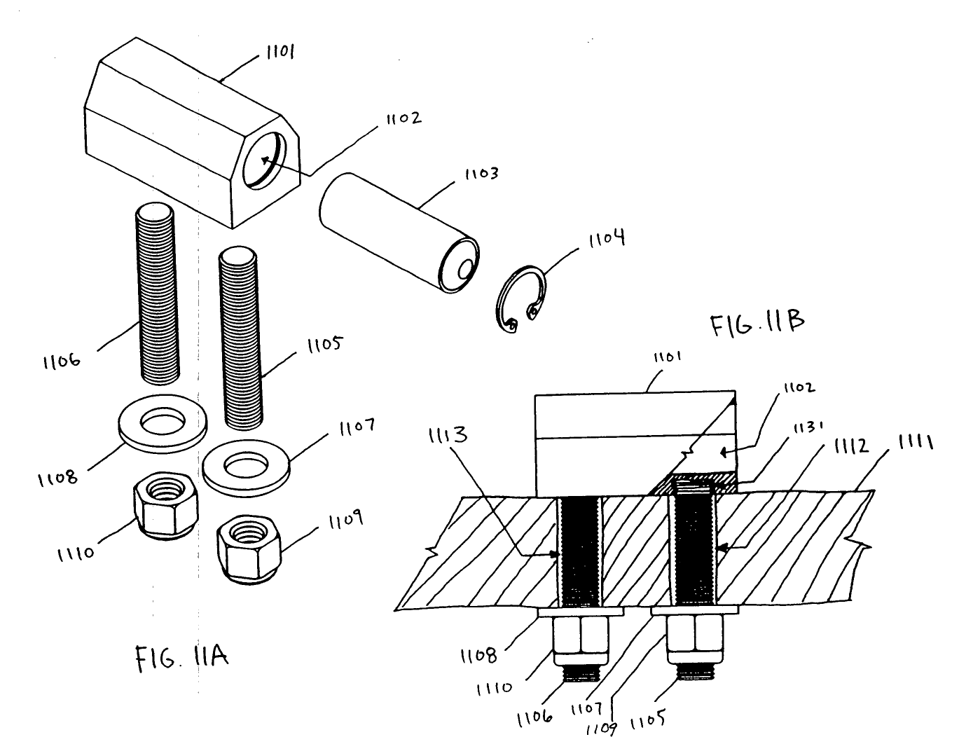

Another structure to integrate a cable lock body assembly to a component of a facility to be secured is shown in FIGS. 10A-10G. In FIG. 10A, a housing 881 is provided to secure a lock body assembly 803 to a component of a covered access opening. The mounting housing 881 carries the cable lock body assembly 803 of a cable lock. The lock body assembly cooperates with a cable such as the cable 8 of the cable seal lock 2 of FIG. 1A. The cable seal lock body 810 is retained in a bore 850 as previously described with respect to other embodiments. The bore or cavity 850 may be arranged and configured to receive and retain the lock body housing 803 as described in connection with previous embodiments. These separate elements may be press fit together, threaded together, secured by adhesive, or the lock body housing 803 held in place by a snap ring such as snap ring 361 of FIGS. 6B-6C.

Mounting housing 881 includes a top portion 882 and a base 890. Top portion 882 carries the lock body assembly 803 in cavity 850. It has a key 892 formed at its bottom surface. It also has a central hole 893 in a top wall and an aligned threaded hole 813 in the bottom wall defining key 892 (best seen in FIGS. 10D and 10E).

Base 890 defines keyway 891, configured to receive key 892 of top portion 882 of housing 881. Base 890 may be integrated with a component of a chamber defining structure or closure member, by welding or other means. Top portion 882 of housing 881 is, in turn, be integrated with base 890 when key 892 of housing 881 is slid into keyway 891 of base 890.

Further, as shown in FIG. 10B, base 890 has a central threaded hole 812 to receive set screw 895, as shown in FIG. 10E. Housing 881 is integrated with base 890 by sliding key 892 into keyway 891 of base 890, as shown in FIG. 10B. With housing 881 integrated with base 890, set screw 895 is passed through hole 893 of housing 881 and screwed into threaded hole 813 of housing 880 and threaded hole 812 of base 890. FIG. 10A shows base 890 and housing 881 integrated and aligned with lock body housing 803 and snap ring 861 in place.

A cable seal is formed when a cable (not shown) is threaded through hole 859 (in FIG. 10C) and into passage 814 of lock body assembly 803 (shown in FIG. 10B).

With both housing 881 and base 890 securely integrated with component 870, lock body 803 is inserted into cavity 850 with the tapered end 813 of lock body assembly 803 proximate wall 858, as shown in the exploded view of FIG. 10B. With lock body assembly 803 in place within cavity 850, snap ring 861 may be placed into groove 860, as shown in FIG. 10A. With set screw 895 in place, housing 881 is securely integrated with base 890. With cable lock body assembly 803 in place in cavity 850, set screw 895 will be inaccessible.

A cable seal is formed when a cable (not shown) is threaded through hole 859 (in FIG. 10C) and into passage 814 of lock body assembly 803 (shown in FIG. 10B). In other embodiments (not shown), keyway 892 can be formed directly into either a chamber defining structure or closure member, thereby avoiding the need for base 890.

In addition, it is contemplated that keyway 891 of base 890 include appropriate holes to receive screws or other fasteners 897 as shown in FIG. 10G to first secure the base to a component 870 of a compartment or closure. The top portion 882 of mounting housing 881 is then attached to the base 890 by sliding key 892 into keyway 891. The assembly is completed by installing lock body housing 803.

Referring to FIG. 10D-10F, a feature of the lock body assembly receptacle is disclosed to provide an indication that one has attempted to defeat a cable seal lock by pulling the cable so as to override the orthogonal force applied to the cable by the lock. As shown in FIG. 10D-10F, wall or flange structure 958 that defines hole 859 be configured to be frangible such that a certain minimum amount of force, which is less than the amount of force required to override the orthogonal pressure applied to the cable by the lock, breaks wall 958 away from housing top portion 882. Where frangible wall 958 has been broken away from housing top portion 882, an inspection of housing 881 will reveal an attempt to defeat the seal. Of course, breaking the housing does not defeat the seal, as the cable remains in the lock; all that a potential saboteur has accomplished is to leave evidence of an attempt to defeat the seal lock.

To facilitate inspection of seals, wall 958 can further include a pattern or marking such that a broken housing can be readily identified and distinguished from a housing that had never included a wall 958. One example of such a marking is shown in FIG. 10F, although other markings would be equally effective. Should wall 958 be broken away from housing 881 in FIG. 10F, marking would look obviously incomplete and an inspector would readily know the seal had been tampered with.

Of course, a breakaway wall 958 could be used in the embodiments already described. Use of breakaway wall 958 in those embodiments involving an indirectly integrated housing such as shown in FIGS. 10A-10G is preferred, however, because an indirectly integrated housing is more easily replaced once wall backing 958 has been broken away from housing 881. If this occurs, housing top portion 882 may be replaced by removing the lock body assembly from the cavity formed by the housing and replacing the top portion of housing 882.

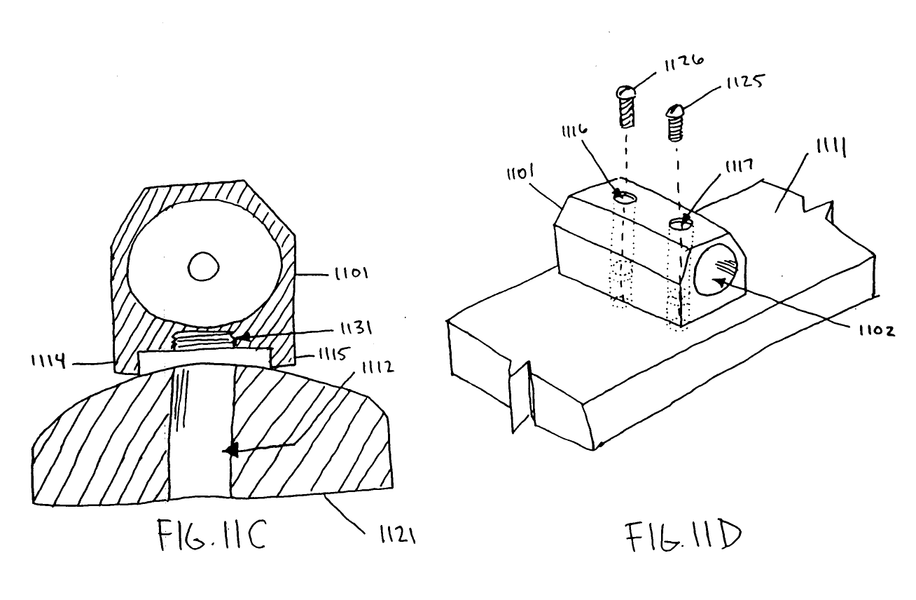

FIGS. 11A-11D depict other integrated cable seal lock embodiments according to the present invention. In FIG. 11A, housing 1101 has cavity 1102 into which cable lock body 1103 can be inserted. Housing 1101 is configured to receive snap ring 1104, as described with reference to FIGS. 6A-6C. The bottom of housing 1101 is also configured to receive threaded studs 1105 and 1106, through complimentarily threaded bores in housing 1101, one of which, threaded bore 1131, is shown in FIG. 11B. Washers 107 and 108 and nuts 109 and 1110 are also configured to receive threaded studs 1105 and 1106.

This embodiment of the present invention can be used to secure housing 1101 to closure or other member 1111, as shown in FIG. 11B, which has bore holes 1112 and 1113 configured to accommodate threaded studs 1105 and 1106. Bore holes 1112 and 1113 are smooth.

To integrate the cable seal lock assembly of this embodiment of the present invention onto such a closure or other member, housing 1101 is first placed over the aforementioned bore holes in the member. Threaded studs 1105 and 1106 are then inserted through the holes 1112 and 1113 of the member 1111 and into the threaded bores 1131 of housing 1101. Threaded studs 1105 and 1106 are configured such that an axial extent of each extends through member 1111, onto which the cable seal lock assembly is integrated. Washers 1107 and 1108 and nuts 1109 and 1110 can then be attached to threaded studs 1105 and 1106 to complete the integration of the cable seal lock assembly.

The holes that receive the studs into the bottom of housing 1101 are preferably blind holes. Loctite Threadlocker (Registered Trademark of Locktite Company) can be used to ensure an acceptably secure integration of threaded studs 1105 and 1106 to housing 1101. Two studs are advantageous in that torque applied to housing 1101 will be insufficient to detach housing 1101 from the studs.

As shown in FIGS. 11C-11D, housing 1101 can be modified according to the demands of a given application. In FIG. 11C, housing 1101 includes on its bottom surface flanges 1114 and 1115 that extend along the lengths of its sides. Flanges 1114 and 1115 can be advantageous in that housing 1101 can be integrated with the curved surface of member 1121.

In FIG. 11D, housing 1101 includes bores 1116 and 1117 through its topmost surface, which are configured to receive screws 1125 and 1126. The configuration of FIG. 11D can be advantageous in that screws 1125 and 1126 can replace the threaded studs 1105 and 1106, shown in FIGS. 11A-11B, and obviate the need for washers and nuts. In such case, the bore holes in the closure member 1111 would be threaded (not shown). The threaded studs and washers and nuts shown in FIGS. 11A-11B could also be used with the modified housing shown in FIG. 11D as well. As described previously with respect to FIG. 10G, placement of the lock body housing assembly into the receptacle defined by the housing precludes access to the screws 1125 and 1126.

The present invention may be embodied in other specific forms without departing from its spirit or essential character. The described embodiments are to be considered in all respects only as illustrative and not restrictive. The scope of the invention is therefore indicated by the appended claims rather than by the foregoing description. All changes which come within the meaning and range of equivalency of the claims are to be embraced within that scope.

We claim:

1. A security mechanism for a covered access opening including a member defining said opening and a relatively movable member defining a cover assembly therefor comprising:
a cable lock assembly comprising:
a cable lock body housing defining a passage sized to receive a cable;
a cable including a first end sized to fit through said cable lock body housing passage and including a second end having an abutment;
a mechanism in said cable lock body housing engageable with said cable to permit movement of said cable through said passage in the direction in which it entered said passage and preventing movement of said cable in the opposite direction;
said cable lock body housing affixed directly to a component of one of said opening defining member and cover.

2. A security mechanism as claimed in claim 1 wherein said cover assembly includes an elongated arm with a catch adapter at one end, said catch adapter defining a cavity, said cable lock body housing being disposed in said cavity and secured to said catch adapter.

3. A security mechanism as claimed in claim 2 wherein said catch adapter defines a wall defining an end of said cavity to restrict movement of said cable lock body housing in one direction, said wall defining a hole to permit passage therethrough of said cable.

4. A security mechanism as claimed in claim 3, wherein said catch adapter defines a groove in said cavity spaced from said flange, and a snap ring is disposed in said groove to secure said cable lock body housing in said cavity, between said flange and said snap ring.

5. A security mechanism as claimed in claim 3 wherein said cover assembly includes a locking clasp with a handle portion, and said handle portion is pivotal relative to said catch adapter and includes side walls with aligned holes and said handle portion has a top wall having a hole therein, and said cable extends through said holes in said side walls of said locking clasp, said hole in said top wall of said handle portion and said passage in said cable lock body housing.

6. A security mechanism as claimed in claim 5 wherein said cable abutment is sized to prevent passage of said abutment through said holes in said locking clasp and said handle portion and is disposed closely spaced to said top wall of said handle portion overlaying said hole therein.

7. A storage or transportation compartment security system comprising:
a structure defining a chamber;
said structure having an access opening to said chamber;
a closure member adapted to be secured to said structure and in position to close said access opening;
a cable lock assembly comprising:
a cable,
a cable lock body housing defining a passage sized to receive a cable;
said cable including a first end sized to fit through said passage and a second end having an abutment;
said abutment being sized to prevent passage of said abutment through said passage:
a mechanism in said cable lock body housing engageable with said cable to permit movement through said passage only in the direction it is inserted and preventing movement in the opposite direction
said cable thus being able to progress through said passage only in the direction in which it entered said passage;
said cable lock body housing being integrated with one of said structure and said closure member.

8. The storage or transportation compartment security system of claim 7 further comprising a separate mounting housing, wherein said housing defines a cavity to receive said cable lock body housing and wherein said housing is mounted directly with at least one of said structure and said closure member and said cable lock body housing is disposed in said cavity.

9. A security mechanism as claimed in claim 8 wherein said housing defines a wall defining an end of said cavity to restrict movement of said cable lock body housing in one direction, said wall defining a hole to permit passage therethrough of said cable.

10. A security mechanism as claimed in claim 9 wherein said wall is frangible and will break before said cable is pulled from said mechanism when pulled in the direction opposite to insertion.

11. A security mechanism as claimed in claim 10, wherein said housing defines a groove in said cavity spaced from said wall, and a snap ring is disposed in said groove to secure said cable lock body housing in said cavity, between said wall and said snap ring.

12. A security mechanism as claimed in claim 10 wherein said closure member includes a locking clasp having a handle portion and said handle is pivotal, and includes side walls with aligned holes and a top wall having a hole therein, and said cable extends through said holes and said passage in said cable lock body housing.

13. A security mechanism as claimed in claim 12 wherein said cable abutment is sized to prevent passage of said abutment through said holes and is disposed closely spaced to said top wall overlaying said hole therein.

14. The storage or transportation compartment security system of claim 1 wherein said cable lock assembly is magnetized and is magnetically secured at said component.

15. The storage or transportation compartment security system of claim 1 wherein said cable lock assembly is adhesively secured to said component.

16. The storage or transportation compartment security system of claim 8 wherein said cable lock assembly and said housing are magnetized to secure them to each other and to said one of said structure and closure member.

17. The storage or transportation compartment security system of claim 8 wherein said mounting housing is adhesively secured to at least one of said structure and said closure member.

18. The storage or transportation compartment security system of claim 1 wherein the exterior surface of said cable lock body housing is threaded and wherein said cavity is threaded to complement said exterior surface of said cable lock body housing, said cable lock body housing being threaded into said cavity.

19. The storage or transportation compartment security system of claim 8 wherein said cavity includes a wall adapted to prevent said cable lock body from passing through said cavity and wherein said wall includes a hole to allow said cable to pass therethrough.

20. The storage or transportation compartment security system of claim 8 wherein said cable lock body is adhesively secured in said cavity.

21. The storage or transportation compartment security system of claim 8 further comprising a strap, wherein said housing is attached to said strap and said strap is secured to at least one of said structure and said closure member.

22. The storage or transportation compartment security system of claim 8 further comprising a ring, wherein said housing includes a hole adapted to receive said ring, and wherein said ring is secured to at least one of said structure and said closure member.

23. The storage or transportation compartment security system of claim 8, wherein said mounting housing includes a separate base and top portion, said top portion and separate base define an engageable keyway structure.

24. The storage or transportation compartment security system of claim 8 wherein said wall is frangible to break away from said housing before said cable can retrogress through said passage of said lock body housing on exertion of a force to remove the cable in the direction opposite its insertion direction.

25. A storage and transportation compartment security system comprising:
a loading nozzle having an access opening and partially defining a chamber;
a closure member comprising a hatch cover adapted to close said access opening, an elongated arm assembly adapted to secure said hatch cover to said access opening, a catch adaptor connected to said elongated arm and a locking clasp adapted to pivot on said catch adaptor such that said elongated arm assembly and said hatch cover can be removed from said access opening;
wherein said catch adaptor includes a cavity adapted to receive a cable lock assembly including a cable lock body defining a passage and a cable having a first end such to pass through said cable lock body passage and a second end having an abutment sized to prevent pass through said passage of said cable lock body;
wherein said locking clasp includes a handle, a first side and a second side, wherein said first side and said second side each include a hole aligned with said cavity of said catch adaptor;
and wherein said locking clasp further includes an aperture in said handle, said holes sized to permit passage of said first end of said cable and prevent passage of said second end.

26. The storage or transportation compartment security system of claim 23 wherein top portion defines said cavity and includes a wall defining an end of said cavity which restricts said cable lock body movement in one direction, said wall housing a hole to permit passage of said cable, said wall is frangible to break away from said top portion housing before said cable can retrogress through said passage of said lock body on exertion of a force to remove the cable in the direction opposite its insertion direction.

27. A storage compartment security system as claimed in claim 23 wherein said base includes threaded members exposed in said keyway, said threaded members secure said base to said one of said structure and closure member, and said housing top portion overlies said threaded member preventing access thereto.

28. A storage or transportation compartment security system as claimed in claim 23 wherein said base and said housing top portion have at least one threaded hole in said keyway portions aligned when said housing top portion is disposed on said base, and a screw secures said housing top portion to said base in said at least one hole, and said cable lock body housing prevents access to said at least one screw when disposed in said cavity.

29. A storage or transportation compartment security system as claimed in claim 28 wherein said top portion defines a wall defining an end of said cavity to restrict movement of said cable lock body in one direction, said wall defining a hole to permit passage therethrough of said cable.

30. A security system as claimed in claim 29, wherein said top portion defines a groove in said cavity spaced from said wall, and a snap ring is disposed in said groove to secure said cable lock body housing in said cavity, between said wall and said snap ring.

31. A security system as claimed in claim 8 wherein said housing defines holes to receive threaded members to secure said housing to a component of said storage or transportation compartment, said holes being covered by said lock body housing when said lock body housing is disposed in said cavity.
